(19) United States
(12) Patent Application Publication
(10) Pub. No.: US 2010/0053610 A1
(43) Pub. Date: Mar. 4, 2010

(54) SYSTEM AND METHOD FOR DETECTING MOLECULES

(76) Inventor: Kwangyeol Lee, Namyangju-si (KR)

Correspondence Address: EDWARDS ANGELL PALMER & DODGE LLP, P.O. BOX 55874, BOSTON, MA, 02205, US

(21) Appl. No.: 12/202,106

(22) Filed: Aug. 29, 2008

(51) Int. Cl. G01J 3/28; B05D 5/00

(52) U.S. Cl. 356/328; 427/164

(57) ABSTRACT

Apparatus and methods for detecting molecules are disclosed. One such embodiment is an apparatus for detecting molecules. The apparatus includes a substrate having a surface; and an array of features formed over the surface in a grating pattern. Each of the features includes a top surface. The apparatus also includes a plurality of receptors coupled to the top surfaces of the features. Each of the receptors is configured to bind to a target molecule. A sample is provided over the substrate while a light is illuminated onto the apparatus. A light scattered by the apparatus is detected by a spectrometer. The presence and/or concentration of target molecules can be determined, based at least partly on a shift in the spectral peak of the light.

### BACKGROUND

Various methods for detecting the presence or concentration of molecules have been developed. For example, in biotechnology, methods for detecting DNA, RNA, or protein molecules have been widely used. In certain detection methods, markers (for example, a fluorescent dye) are tagged to target molecules. Then, markers that are tagged to the target molecules are detected to indirectly determine the presence or concentration of the target molecules. Examples of such methods include flow cytometry, nucleic acid hybridization, DNA sequencing, nucleic acid amplification, immunoassays, histochemistry, and functional assays involving living cells fluorescence spectroscopy, and Raman spectroscopy.

In some instances, a concentration of target molecules in a sample may be too low. In such instances, the methods described above may not be suitable for detecting the presence of the target molecules in the sample. In addition, tagging markers to target molecules may be time-consuming.

### SUMMARY

The systems, methods, and devices described herein each have several aspects, no single one of which is solely responsible for its desirable attributes.

An aspect by way of non-limiting example includes an apparatus for detecting molecules. The apparatus includes a substrate including a surface; and an array of features formed over the surface in a grating pattern. Each of the features can include a top surface, wherein the features are formed of a material that is configured to produce surface plasmon resonance (SPR) when illuminated. The apparatus also can include one or more receptors coupled to the top surfaces of the features. Each of the receptors can be configured to bind to a target molecule.

Another aspect by way of non-limiting example includes a method of detecting molecules. The method can include providing a grating structure that includes an array of features formed over a surface of a substrate in a repeating pattern. Each of the features can include a top surface, wherein the features are formed of a material that produces surface plasmon resonance (SPR) when illuminated with a light. The grating structure also can include one or more receptors coupled to the top surfaces of the features, wherein each of the receptors is configured to bind to a target molecule. The method also can include one or more of contacting a sample containing one or more molecules with the grating structure; directing a light to the grating structure; and detecting the presence of a target molecule in the sample, for example, based at least in part on a change in surface plasmon resonance spectrum.

Yet another aspect by way of non-limiting example includes a method of making a molecule sensor. The method can include forming an array of features over a surface of a substrate in a repeating pattern, wherein the features are formed of a material that produces surface plasmon resonance (SPR) when illuminated with a light. The method also can include attaching one or more receptors to a top surface of the features. Each of the receptors can be configured to bind to a target molecule.

Yet another aspect by way of non-limiting example includes a kit for detection of molecules. The kit can include: a substrate including a surface; and an array of features formed over the surface in a repeating pattern. Each of the features can include a top surface. The kit also can include one or more receptors attachable to the features. Each of the receptors can be configured to bind to a target molecule.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

The embodiments will be better understood from the Detailed Description and from the appended drawings, which are meant to illustrate and not to limit the embodiments.

FIG. 1A is a schematic diagram of an illustrative embodiment of a system for detecting molecules, including a grating structure.

FIG. 1B is a top plan view of the grating structure of FIG. 1A.

FIG. 2A is a graph illustrating the spectral peak of a plasmon produced by a nanoparticle.

FIG. 2B is a graph illustrating the spectral peak of a plasmon produced by an illustrative embodiment of a grating structure.

FIG. 3 shows an illustrative embodiment of a method of detecting molecules using the system of FIG. 1A.

FIG. 4A is a graph illustrating the spectral peak of a plasmon produced by the grating structure of FIG. 3 when there is no target molecule bound to the grating structure.

FIG. 4B is a graph illustrating the spectral peak of a plasmon produced by the grating structure of FIG. 3 when there are target molecules bound to the grating structure.

FIGS. 5A-5E show an illustrative embodiment of a method of making a grating structure.

FIGS. 6A-6D show another illustrative embodiment of a method of making a grating structure.

FIGS. 7A-7D show yet another illustrative embodiment of a method of making a grating structure.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The following detailed description is directed to certain specific embodiments. However, the embodiments can be varied in a multitude of different ways. As will be apparent from the following description, the embodiments may be implemented in or associated with a variety of devices and methods.

In certain aspects of the disclosure, the presence and/or concentration of molecules in a sample can be detected with systems, apparatus and methods that utilize surface plasmon spectroscopy (SPS). Plasmons are the collective vibrations of an electron gas (or plasma) surrounding the atomic lattice sites of a metal. When plasmons couple with a photon, the resulting particle is called a polariton. This polariton propagates along the surface of the metal until it decays, either by absorption, whereupon the energy is converted into phonons, or by a radiative transition into a photon.

Surface plasmon spectroscopy detects the excitation of surface plasmons by monitoring a reflected light from the metal. One example of surface plasmon spectroscopy is disclosed in Willets et al., “Localized Surface Plasmon Resonance Spectroscopy and Sensing,” Annu. Rev. Phys. Chem. 2007. 58, pp. 267-297 (Oct. 19, 2006), the disclosure of which is incorporated herein by reference in its entirety.

Certain nanoparticles, for example, Gold (Au) and silver (Ag) nanoparticles with sub-wavelength size, show plasmon scattering resonance at visible wavelengths (about 400 to about 700 nm). Attachment of molecules onto the nanoparticles shifts the resonance wavelengths. However, the plasmon-resonance spectral peaks of the metal nanoparticles alone are usually broad (about 50-100 nm in wavelengths) compared to the resonance frequency shift caused by the attached molecules (about 5 to about 10 nm). This can limit the ability to detect molecules using SPR. As disclosed herein, the plasmon-scattering spectra from periodically arranged nanoparticles can be significantly narrower than those from the isolated nanoparticles because of the far-field interference. Therefore, some embodiments of the disclosure relate to the use of periodically arranged features, for example, metal nanoparticles, to enhance detection sensitivity of the plasmon-shift molecule sensors.

In some embodiments, the molecule sensing does not necessarily rely on the fluorescence or Raman scattering signals and hence it does not require any extra labeling. The sensor can be utilized in various applications where detection of molecules or materials is desired, for example, DNA or proteome screening and drug discovery, to name just a few applications.

In one aspect, a grating structure can be used for surface plasmon spectroscopy. The grating structure includes a substrate including a surface, and an array of features formed in a repeating pattern over the surface. In some aspects the pitch of the grating structure can be sufficiently greater than the dipole-dipole coupling distance (equal to or smaller than about 20 nm) between the features. The grating structure also can be functionalized with receptors. That is, the structure can include a plurality of receptors coupled to the surface of the features. Each of the receptors is configured to bind to a target molecule. A sample is contacted with the grating structure such that target molecules in the sample can bind to the receptors. The grating structure is illuminated by a light source, and a scattered light from the grating structure is detected by a spectrometer. If there are target molecules bound to the surface of the grating structure, there will be a shift in the resonance wavelength. A shift in the resonance wavelength of the scattered light is detected to determine the presence and/or concentration of the target molecules in the sample.

### Molecule Sensor System

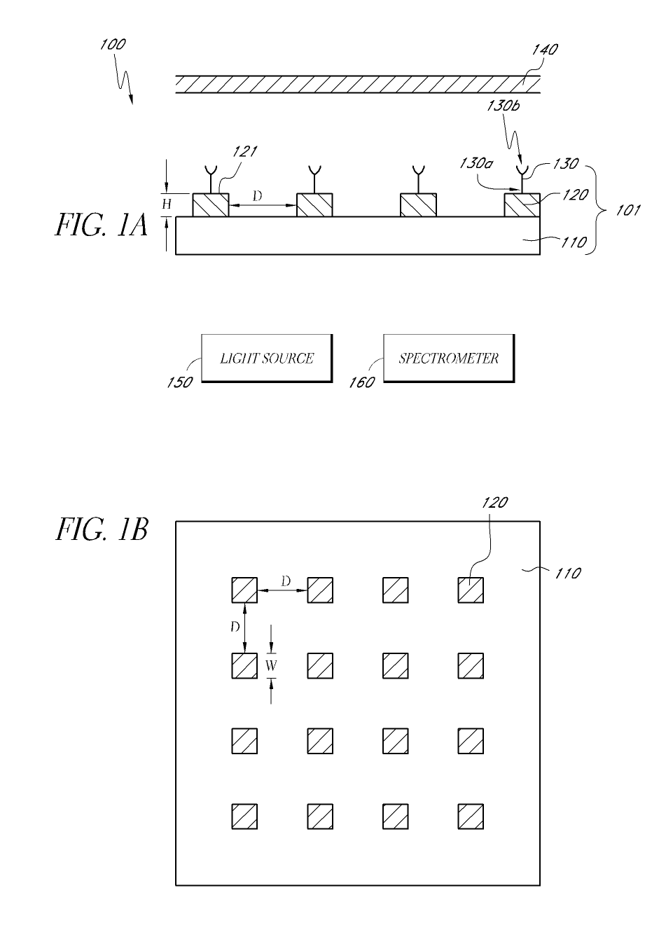

Referring to FIGS. 1A and 1B, a system for detecting molecules according to one embodiment will be described below. The illustrated system 100 includes a grating structure 101 that includes a substrate 110, an array of features 120, and a plurality of receptors 130. The system 100 also includes a mirror 140, a light source 150, and a spectrometer 160.

The substrate 110 may be formed of any suitable material. In some aspects the substrate 110 may be formed of a substantially transparent material. Examples of such materials include, but are not limited to, an oxide (e.g., silicon oxide), glass, a polymer (e.g., polyethylene terephthalate (PET)) or the like. In some aspects, the substantially transparent material can have a transmittance of, for example, about 70% to about 100%, optionally about 80% to about 100%. The transmittance can be, for example, about 80%, or about 90%. In other embodiments, the substrate 110 may be formed of a translucent material. In view of this disclosure, a skilled artisan will appreciate that the substrate 110 can be formed of any other suitable material.

In the illustrated embodiment, the array of features 120 may include a plurality of features formed over the top surface 111 of the substrate 110, as shown in FIGS. 1A and 1B. The term “feature” refers to a structure of the substrate that can be used to generate surface plasmon resonance (SPR) spectra that can be used to detect molecules bound to receptors attached to the features. In some aspects, the term “feature” can refer to structures that protrude from a surface of a substrate. In other embodiments, the features may be embedded such that only the top portions of the features are exposed. In the illustrated embodiment, each of the features 120 is cube-shaped. In other embodiments, the features can have other shapes, such as a rectangular shape (including an elongated rectangular shape), cylindrical shape, a pyramid shape, a truncated pyramid shape, a conical shape, a truncated conical shape, or the like.

The features 120 can have a top surface 121 that has a square shape, a rectangular shape, a circular shape, a spherical shape, a pyramidal shape, a triangular shape, a hexagonal shape, or the like. The features 120 can have side surfaces 122 that have a square shape, a rectangular shape, a triangular shape, a trapezoidal shape, or the like.

It should be noted that FIGS. 1A and 1B shows only a portion of the grating structure 101. The features 120 shown in FIGS. 1A and 1B can be repeated across the top surface 111 of the substrate 110. Although the illustrated portion includes a structure with four rows and four columns (e.g., 4×4) of features 120, various configurations can be utilized. For example, in some aspects, only one row or one column of features may be utilized, for example, 1×2, 1×3, 1×4 to 1×1000, etc. In other aspects, the array can include, for example, 2×2, 2×3, 2×4 to 2×1000, etc. or more features. Also, there can be more than 2 rows or columns, for example, from about 1 to about 1000 with a similar number of cross rows or columns, if desired.

In the illustrated embodiment where the top surface of the feature 120 has a square shape, the top surface may have a width W of about 20 nm to about 150 nm, or optionally about 30 nm to about 120 nm. The width W can be, for example, about 40 nm, or about 80 nm. The features can have a height H of about 5 nm to about 50 nm, or optionally about 10 nm to about 40 nm. The height H can be, for example, about 15 nm, or about 30 nm.

The features 120 may be formed of a material suitable for generating surface plasmon resonance (SPR). Examples of such materials include, but are not limited to, noble metals, such as gold (Au), silver (Ag), and combinations thereof For example, in some aspects the features can be or include Gold (Au) and/or silver (Ag) nanoparticles, for example.

The features 120 may be arranged in a grating or repeating pattern. In the illustrated embodiment, the features 120 are arranged in a square matrix or square array form. In other embodiments, the features can be arranged in any other suitable repeating, periodic, and/or uniform pattern. The features 120 arranged in the grating pattern collectively can serve as a grating structure that can change surface plasmon resonance (SPR) spectra. In one aspect, the features can be arrayed to form a structure (e.g., a grating structure) that is configured to provide an SPR spectrum having a peak narrower than an SPR spectrum from an isolated feature or nanoparticle. As discussed above, the narrower spectrum can permit the systems, for example, to detect shifts caused by bound target molecules. The features 120 may be laterally spaced from one another. A distance D between two adjacent features 120 can be equal to or greater than about 20 nm, for example. In one embodiment, the distance D between the features 120 can be about 50 nm to about 300 nm, or optionally about 100 nm to about 250 nm. The distance D can be, for example, about 120 nm or about 150 nm.

Receptors 130 may be attached to the surface(s) of the features 120. For example, one or more receptors 130 may be coupled to the top surface 121 of each of the features 120. In the illustrated embodiment, substantially no receptors may be coupled to the side surfaces of each of the features 120. Each of the receptors 130 can include a first end 130a coupled to the top surface 121 of the features 120, and a second end 130b configured to bind specifically to a target molecule. Examples of receptors include but are not limited to an antibody, a nucleic acid, a ligand, an antigen, as well as other aptamers, biochemicals and chemicals. Examples of target molecules include, but are not limited to, a nucleic acid (e.g., DNA molecules, RNA molecules), oligonucleotides, proteins, an antibody, an antigen, an antibody, an aptamer, a protein, an enzyme, a receptor, a natural or synthetic drug, a synthetic polymer, a hormone, an enzyme, a cell, a microorganism, a lymphokine, a cytokine, a toxin, a ligand, a hapten, a carbohydrate, a sugar, a liposome, other biomolecules, chemicals including small molecule compounds, and the like. In other embodiments, the target molecule can be any organic or inorganic molecule or a polymer.

The system can include a mirror or reflective device. Referring to FIG. 1A, a mirror 140 is positioned over the substrate 1 10, facing the array of the features 120. The mirror 140 serves to reflect light or emission from the grating structure 101 so as to enhance the detection by the spectrometer 160 of the light or emission. The mirror 140 can be formed of any suitable specular material, such as aluminum or silver. In one embodiment, the mirror 140 can be formed of optical fiber.

The light source 150 may serve to emit light, for example to emit white light (visible light) and/or near-infrared light to the grating structure 101. The illustrated light source 150 is positioned under the substrate 110 such that light emitting from the light source 150 passes the substrate 110 before reaching a region above the substrate 110. In view of the instant disclosure, a skilled artisan will, however, appreciate that the light source 150 can be positioned at any other suitable position. In one embodiment, the light source 140 may include one or more xenon (Xe) or tungsten (W) lamps, for example.

The system can include a spectrometer. In FIG. 1A the spectrometer 160 is configured to detect light or emission from the grating structure 101. The illustrated spectrometer 160 is positioned under the substrate 110. In view of the instant disclosure, a skilled artisan will, however, appreciate that the spectrometer 160 can be positioned at any other suitable position. In view of the instant disclosure, a skilled artisan will appreciate that any suitable types of spectrometers can be adapted for use in the system 100.

Some aspects of the disclosure relate to kits. For example, in some aspects a kit may include components for the system described above. The kit may include, for example, a substrate having a surface, and an array of features formed over the surface in a periodic or repeating pattern. The details of the substrate and the features can be as describe elsewhere herein. The kit may also include a plurality of receptors attachable to the top surfaces of the features. Each of the receptors may be configured to bind to a target molecule. The details of the receptors can be as described above and elsewhere herein. The kit may further include at least one of a mirror, a light source, or a spectrometer. The details of the mirror, the light source, or the spectrometer can be as described above and elsewhere herein.

### Method of Detecting Molecules

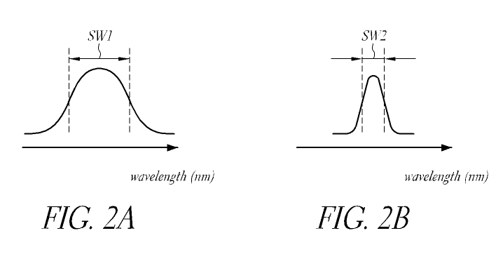

Typically, a plasmon generated by a single nanoparticle (having, for example, a size of about 10 nm to about 250 nm) has a spectral peak of a relatively large width SW1 in wavelength (for example, about 50 nm to about 400 nm), as shown in FIG. 2A, when detected by a spectrometer. In the context of this document, the width of a peak refers to a half-width measured at about 50% of the height of the peak. The large peaks can make it difficult to detect resonance frequency shifts, which may be, for example, about 5 to about 10 nm. In contrast, use of the grating structures disclosed herein may produce a plasmon having a spectral peak of a relatively small width SW2 in wavelength (for example, about 10 nm to about 100 nm, or about 20 nm to about 50 nm), as shown in FIG. 2B, when detected by a spectrometer.

When a molecule binds to such a nanoparticle, the peak produced by the plasmon of the nanoparticle may shift in a direction by, for example, about 5 nm to about 10 nm. However, as mentioned above, because the peak is relatively wide, the shift of the peak cannot be easily detected. In contrast, the grating structure described above provides a relatively narrow peak, and thus can improve the sensitivity for the detection of resonance frequency shifts. Therefore, target molecules, even in very low (e.g., femto mole) amounts can be detected.

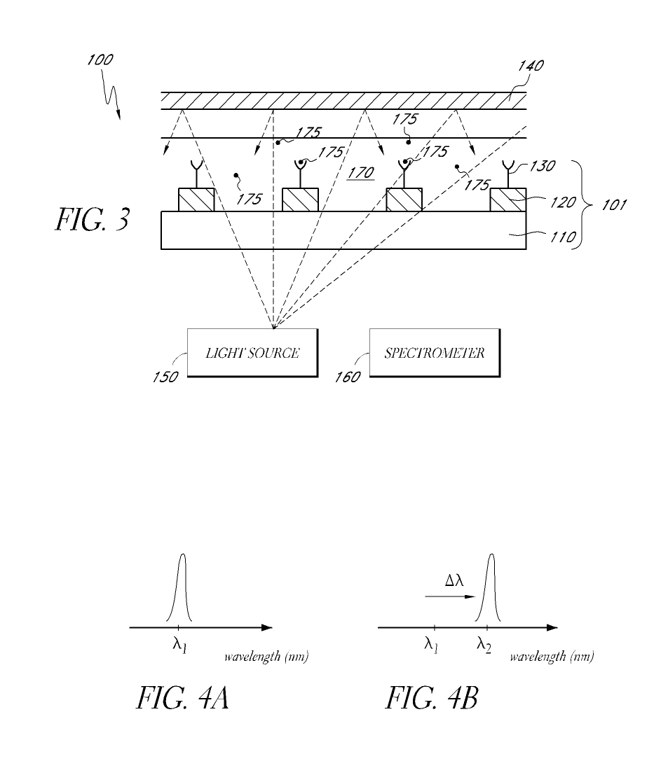

Referring to FIG. 3, a method of detecting molecules according to one embodiment will be described below. The methods of detecting target molecules will be described in connection with an example system 100 of FIG. 3. It should be understood that other systems disclosed or described herein can also be used in the methods of detecting molecules. Referring to FIG. 3, a sample 170 is added to the system 100 such that the sample 170 is spread over or contacted with the substrate 110. The sample 170 may or may not contain target molecules. In one embodiment, the substrate 110 can be shaken laterally and/or vertically to facilitate the binding of target molecules 175, if any, to the receptors 130.

If the sample 170 contains target molecules 175, one or more of the target molecules 175 may bind to the receptors 130, as shown in FIG. 3A. Examples of target molecules are provided above.

A light is directed through the substrate 110 by the light source 150. The light passes through the substrate 110 and reaches at least the features 120 and the receptors 130. In one aspect, the light may reach the features 120 at a particular angle with reference to the top surface 111 of the substrate 110. The angle can be between about 0° and about 60°, optionally between about 0° and about 30°. The angle can be, for example, about 10° or about 20°. The light may cause surface plasmon resonance (SPR) at the features 120, generating SPR wave spectra. The SPR spectra may be reflected by the mirror 140, and detected by the spectrometer 160.

It is determined whether there is a shift in the surface plasmon resonance spectral peak of the light. As shown in FIG. 4A, the grating structure 101 may produce a surface plasmon resonance spectral peak having a maximum at a first wavelength λ₁ when there is no target molecule bound to it. Such a peak may be referred to as a reference (spectral) peak in the context of this document. If there are one or more target molecules bound to the grating structure 101, the peak shifts in a direction such that the maximum of the peak is at a second wavelength λ₂ that is different from the first wavelength λ₁. In the illustrated example, the peak shifts to the right, increasing the wavelength at which the peak has the maximum. Such a peak shift indicates that there are target molecules in the sample 170. In certain instances, the peak shift is about 5 nm to about 10 nm.

In certain embodiments, an amount of the peak shift can be determined. For example, in the illustrated embodiment, the amount of the peak shift is a difference between the wavelengths of the maximums of the peaks before and after providing the sample 170. That is, the amount of the peak shift is a difference Δλ between the first wavelength λ₁ and the second wavelength λ₂.

The amount of the shift may be linearly proportional to the concentration of the target molecules. The concentration of target molecule may be obtained by calibrating the shift with respect to a standard or reference sample having a precisely known concentration. Thus, the concentration of the target molecules in the sample 170 can be determined, based at least partly on the amount of the peak shift. In certain embodiments, the concentration of target molecules can be determined on a femto-mole (10⁻¹⁵ mole) scale.

### Methods of Making A Grating Structure

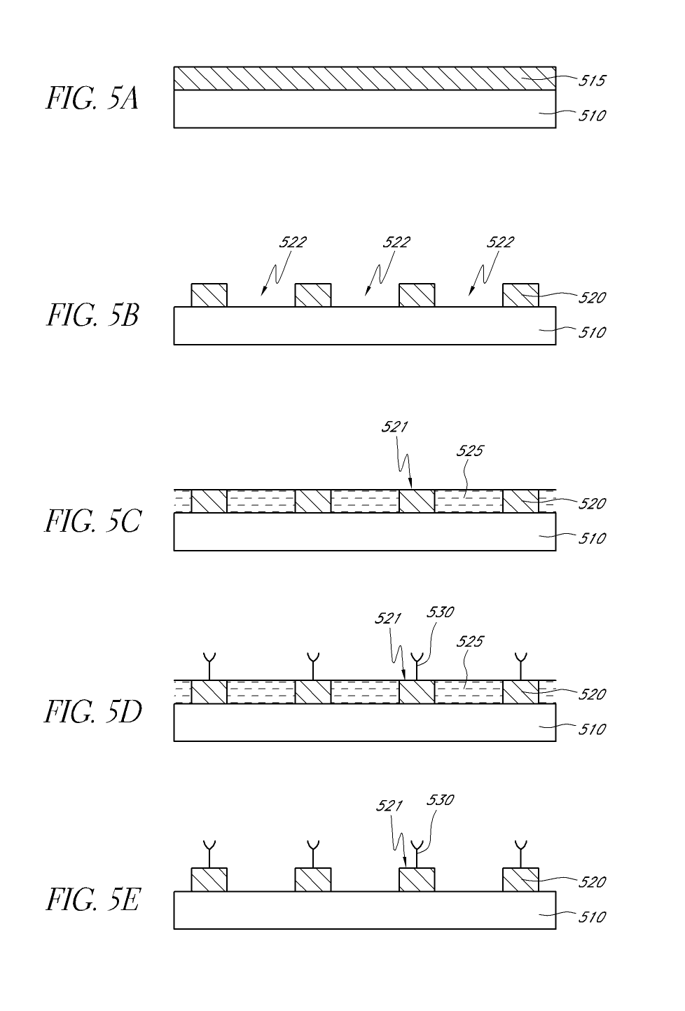

Referring to FIGS. 5A-5E, one example of a method of making a grating structure according to one embodiment will be described. First, a substrate 510 is provided as shown in FIG. 5A. The details of the substrate 510 can be as described above in connection with FIG. 1A. A layer 515 is formed on the substrate 510 with a material suitable for surface plasmon resonance (SPR). Examples of such materials include, but are not limited to, gold (Au), silver (Ag), combinations thereof, and the like.

In FIG. 5B the layer 515 is patterned to form an array of features 520 and gaps 522 between the features 520. In one embodiment, the layer 515 may be patterned using a lithographic process, such as photolithography or e-beam lithography, for example. In other embodiments, the layer 515 may be patterned using an imprinting technique. The details of the array of features 520 can be as described elsewhere herein, including as described above in connection with the examples of FIGS. 1A and 1B.

As shown in FIG. 5C, the gaps 522 between the features 520 may be filled with a gap-filler or a sacrificial material 525. The gap-filler or sacrificial material 525 may be a material that does not react with or attach to receptors, which are described below and elsewhere herein. Examples of such materials gap-filler materials include, but are not limited to, a photoresist, a dielectric material (such as SiO₂), or the like.

In one embodiment, the gap-filler 525 can be blanket deposited over the features 520 and exposed portions of the substrate 510, and then can be partially removed to expose the top surfaces 521 of the features 520. In another embodiment, the gap-filler 525 may be spin-coated over the exposed portions of the substrate 510 in the gaps 522 while exposing the top surfaces 521 of the features 520.

Receptors 530 are contacted with the structure resulting from the step of FIG. 5C. Each of the receptors 530 can include a first end that can be coupled to the top surfaces 521 of the features 520, and a second end configured to bind specifically to a target molecule. The receptors can be attached to the surface of the features as described below and elsewhere herein. Examples of target molecules are disclosed above.

In one embodiment, linkers are attached to the top surfaces 521 of the features 520 before providing the receptors 530. The linkers may be molecules that include a carboxyl group (—COOH) at one end, and a thiol group (—SH) at another end. The thiol group may be attached to the top surface 521 of the features 520. In one embodiment, the linkers may be represented by the formula, HOOC—(CH₂)ₙ—SH, where n is 1 to 5. Then, the receptors 530 that include an amino functional group (NH₂) at a first end are provided over the features 520 and the gap-filler 525. The amino functional group of each of the receptors 530 reacts with the carboxyl group of each of the linkers, and forms an amido (—CONH—) link, thereby attaching the first end of the receptor to the top surface 521 of the feature 520.

The gap-filler 525 is then removed, as shown in FIG. 5E. The gap-filler 525 can be removed by any suitable method, depending on the material of the gap-filler 525.

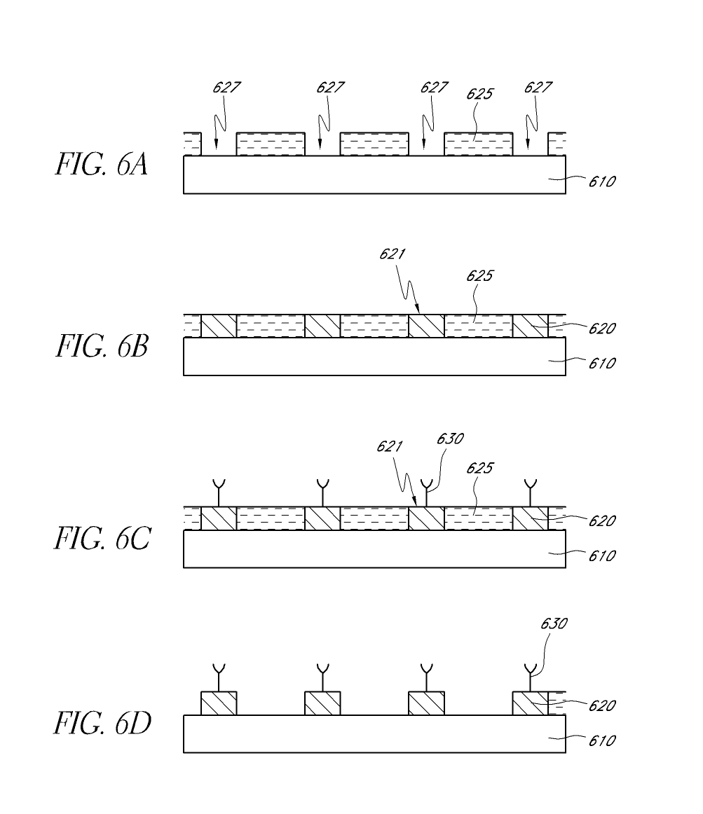

Referring to FIGS. 6A-6D, a method of making a grating structure according to another embodiment will be described. First, a substrate 610 is provided as shown in FIG. 6A. The substrate 610 can be substrate as described above, for example, in connection with FIG. 1A.

A layer 625 is formed and patterned on the substrate 610. The layer 625 may be formed of a material that is the same as the gap-filler material 525 of FIG. 5C, for example. The layer 625 is patterned to form openings 627 that expose portions of the substrate 610. The openings 627 are formed where an array of features is to be formed, as will be described below. In one embodiment wherein the layer 625 is formed of a photoresist, the layer 625 may be patterned by any suitable photolithographic process. In another embodiment, the patterned layer 625 may be formed by any suitable technique, such as inkjet printing or imprinting.

The openings 627 are filled with a material suitable for surface plasmon resonance (SPR), forming an array of features 620 in the openings 627, as shown in FIG. 6B. Examples of such materials include, but are not limited to, gold (Au), silver (Ag), combinations thereof, and the like. In one embodiment, the material for the features 620 can be blanket deposited over the layer 625 and exposed portions of the substrate 610, and then be partially removed to expose the top surfaces 621 of the features 620. In one embodiment, the material may be removed by any suitable planarization technique, such as chemical mechanical polishing (CMP). In another embodiment, the material may be spin-coated into the openings 627 of the layer 625, for example.

Receptors 630 can be attached to the top surfaces of the features 620, as shown in FIG. 6C. The details of this step can be as described above in connection with FIG. 5D. Finally, the layer 625 is removed by any suitable method, depending on the material of the layer 625, as shown in FIG. 6D.

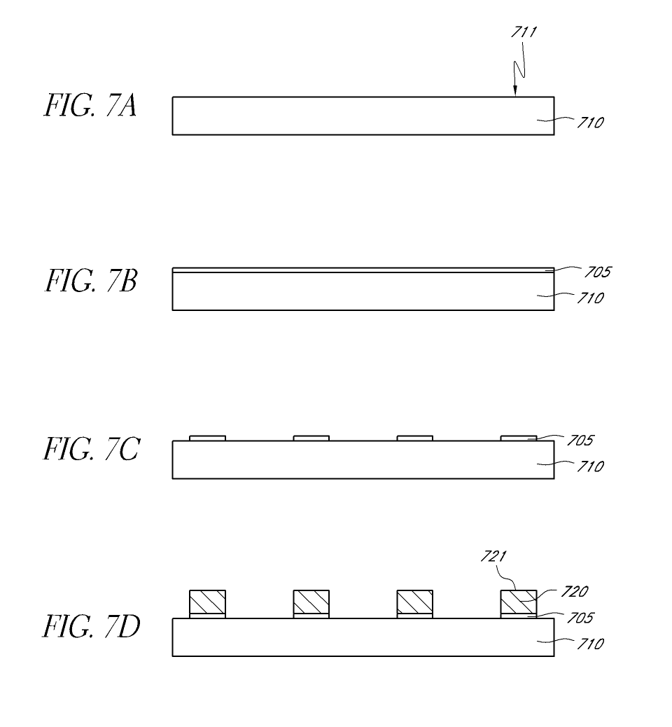

Referring to FIGS. 7A-7D, a method of making a grating structure according to yet another embodiment is described. First, a substrate 710 is provided as shown in FIG. 7A. The details of the substrate 710 can be as described above, for example, in connection with FIG. 1A.

A monolayer 705 is formed on the substrate 710, as shown in FIG. 7B. The term “monolayer” refers to a single layer of atoms or molecules. The monolayer 705 may be formed, for example, of a material that can form a self-assembled monolayer (SAM). The material may include a thiol group (—SH). The layer 705 can be attached to the surface 711 of the substrate 710, forming a dithiol link that can be represented by, for example, HS—X—SH, where X is an unsaturated or saturated hydrocarbon chain or aromatic rings. For example, the saturated hydrocarbon may be represented by (CH)ₙ, where n is 1 to 20.

The monolayer 705 then can be patterned to form an array of islands or discrete regions 706 in a repeating pattern by any suitable method, as shown in FIG. 7C. The islands 706 are formed where features are to be formed, as will be described below.

Next, a solution containing a material for forming features 720 is provided over the structure of FIG. 7C. Examples of such materials include, but are not limited to, gold (Au), silver (Ag), combinations thereof and the like. The solution can be heated to about 40° C. to about 50° C., such that the material in the solution is crystallized into single crystalline nanoparticles. Then, receptors (not shown) can be attached to the top surfaces 721 of the features 720, as described above, for example, with reference to FIGS. 6A-6D.

### Applications

The system and method for detecting molecules of the embodiments described above can be effective even in the absence of labels or markers, such as fluorescent dye molecules. Markers are not necessarily required. Thus, detection of molecules can be simplified. The system and method described above can be adapted for the detection of molecules, even at a relatively low concentration in various applications. For example, the system can be used as a biosensor for DNA, RNA, or protein in various applications, including, but not limited to, chemical, biological, or pharmaceutical applications, or disease diagnostics.

The embodiments above are described in the context of detection of molecules by plasmon scattering. In view of the instant disclosure, a skilled artisan will, however, appreciate that the embodiments can be adapted for any type of spectroscopy where the grating structure described above can improve the sensitivity of the spectroscopy.

In at least some of the aforesaid embodiments, any element used in an embodiment can interchangeably be used in another embodiment unless such a replacement is not feasible. It will be appreciated that the steps of the methods described above can be combined, divided, or omitted or that additional steps can be added. It will also be appreciated by those skilled in the art that various other omissions, additions and modifications may be made to the methods and structures described above without departing from the scope of the embodiments.

For purposes of this disclosure, certain aspects, advantages, and novel features of the embodiments are described herein. It is to be understood that not necessarily all such advantages may be achieved in accordance with any particular embodiment. Thus, for example, those skilled in the art will recognize that some embodiments may be embodied or carried out in a manner that achieves one advantage or group of advantages as taught herein without necessarily achieving other advantages as may be taught or suggested herein.

The herein described subject matter sometimes illustrates different components contained within, or connected with, different other components. It is to be understood that such depicted architectures are merely illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An apparatus for detecting molecules, comprising:
a substrate including a surface;
an array of features formed over the surface in a grating pattern, each of the features including a top surface, wherein the features are formed of a material that is configured to produce surface plasmon resonance (SPR) when illuminated; and
one or more receptors coupled to the top surfaces of the features, each of the receptors being configured to bind to a target molecule.

2. The apparatus of claim 1, wherein the substrate is formed of a substantially transparent material or a translucent material.

3. The apparatus of claim 1, wherein the substrate comprises at least one selected from the group consisting of an oxide, glass, and a polymer.

4. The apparatus of claim 1, wherein the top surface of at least one of the features has a width of about 20 nm to about 150 nm.

5. The apparatus of claim 1, wherein the features are spaced apart from one another, and wherein a distance between two of the features is about 50 nm to about 300 nm.

6. The apparatus of claim 1, wherein one or more of the features have a height of about 5 nm to about 50 nm.

7. The apparatus of claim 1, wherein the features are formed of a metallic material.

8. The apparatus of claim 7, wherein the metallic material comprises one or more selected from the group consisting of gold (Au) or silver (Ag).

9. The apparatus of claim 1, further comprising a self-assembled monolayer (SAM) interposed between one of the features and the surface of the substrate.

10. The apparatus of claim 1, wherein the target molecule comprises at least one selected from the group consisting of a DNA molecule, an RNA molecule, an oligonucleotide, a protein, and a hormone.

11. The apparatus of claim 1, further comprising a mirror positioned to reflect light and/or emission from the substrate.

12. The apparatus of claim 1, further comprising a light source.

13. The apparatus of claim 1, further comprising a spectrometer.

14. A method of detecting molecules, the method comprising:
providing a grating structure that includes:
an array of features formed over a surface of a substrate in a repeating pattern, each of the features including a top surface, wherein the features are formed of a material that produces surface plasmon resonance (SPR) when illuminated with a light; and
one or more receptors coupled to the top surfaces of the features, each of the receptors being configured to bind to a target molecule;
contacting a sample containing one or more molecules with the grating structure;
directing a light to the grating structure; and
detecting the presence of a target molecule in the sample, based at least in part on a change in surface plasmon resonance spectrum.

15. The method of claim 14, wherein detecting the presence of a molecule comprises detecting the resonance wavelength of a light scattered by the grating structure.

16. The method of claim 15, wherein detecting the presence of a molecule comprises determining a spectral peak from the scattered light.

17. The method of claim 16, further comprising determining if there is a difference between the spectral peak of the detected light and a reference spectral peak, the reference spectral peak being a spectral peak detected without providing a sample to the grating structure.

18. The method of claim 17, further comprising determining an amount of the difference, wherein the difference is proportional to the concentration of target molecules in the sample.

19. The method of claim 14, wherein the features are formed of a metallic material.

20. The method of claim 19, wherein the metallic material comprises one or more selected from the group consisting of gold (Au) or silver (Ag).

21. The method of claim 14, wherein the substrate is formed of a substantially transparent or translucent material, and wherein illuminating the light comprises illuminating the light such that the light passes the substrate before reaching the array of features.

22. The method of claim 14, wherein illuminating the light comprises using visible light and/or near infrared light.

23. A method of making a molecule sensor, the method comprising:
forming an array of features over a surface of a substrate in a repeating pattern, each of the features including a top surface, wherein the features are formed of a material configured to produce surface plasmon resonance (SPR) when illuminated; and
attaching one or more receptors to the top surface of the features, each of the receptors being configured to bind to a target molecule.

24. The method of claim 23, wherein the substrate is substantially transparent or translucent.

25. The method of claim 23, wherein forming the array of features comprises:
depositing a first layer with a first material on the substrate; and
patterning the first layer to form the array of features with gaps between adjacent features.

26. The method of claim 25, wherein attaching one or more receptors comprises:
forming a second layer with a sacrificial material to fill the gaps between the features; and
attaching the receptors to at least the features while the second layer fills the gaps; and
removing the second layer.

27. The method of claim 23, wherein forming the array of features comprises:
forming a self-assembled monolayer (SAM) over the substrate;
patterning the self-assembled monolayer to form an array of elevated structures have gaps between adjacent elevated structures; and
forming the array of features on the array of elevated structures.

28. The method of claim 27, wherein attaching the one or more receptors comprises:
forming a second layer with a sacrificial material to fill the gaps between the features; and
attaching the receptors to at least the features while the second layer fills the gaps; and
removing the second layer.

29. The method of claim 23, wherein forming the array of features comprises:
forming a first layer with a sacrificial material;
patterning the first layer to form a plurality of openings;
filling the plurality of openings with a material for forming the features; and
removing the first layer.

30. The method of claim 29, wherein attaching a plurality of receptors comprises: attaching the receptors to at least the features after filling the plurality of openings and before removing the first layer.

31. A kit for detection of molecules, comprising:
a substrate including a surface;
an array of features formed over the surface in a repeating pattern, each of the features including a top surface; and
one or more receptors attachable to the features, each of the receptors being configured to bind to a target molecule.

32. The kit of claim 31, wherein the target molecule comprises at least one selected from the group consisting of a DNA molecule, an RNA molecule, an oligonucleotide, a protein, and a hormone.

33. The kit of claim 31, further comprising a mirror shaped to reflect light and/or emission from the substrate.

34. The kit of claim 31, further comprising a light source.

35. The kit of claim 31, further comprising a spectrometer.
